(19) United States
(12) Patent Application Publication
(10) Pub. No.: US 2010/0264324 A1
(43) Pub. Date: Oct. 21, 2010

(54) RADIATION DETECTOR COMPRISING AN IMAGING RADIATION-COLLIMATING STRUCTURE

(75) Inventors: Bart Pierre Antoine Jozef Hoornaert, Arendonk (BE); Getty Wissink, Eindhoven (NL); Tiemen Poorter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,941

(22) PCT Filed: Nov. 17, 2008
(86) PCT No.: PCT/IB08/54808

§ 371 Date: May 14, 2010

(30) Foreign Application Priority Data
Nov. 19, 2007 (EP) 07120952.2

(51) Int. Cl. G01T 1/24

(52) U.S. Cl. 250/370.09; 250/370.08

(57) ABSTRACT

The invention relates to a radiation detector (3) comprising a detector array (5) having a periodical pattern of detector elements (51). Each detector element (51) comprises a sensor element (53) for converting incident radiation into an electrical charge. The sensor elements (53) are spaced at a sensor-center-to-center distance. Over the detector array (5) an imaging radiation-collimating structure (7) is disposed. The imaging radiation-collimating structure has a periodical pattern of radiation absorbing elements, which radiation absorbing elements are being spaced at a collimator center-to-center distance. The radiation detector (3) comprises a combiner for generating combiner-signals from the electrical charges of the sensor elements (53) of groups of an even number of sensor elements adjacent in a direction of the periodicity of the pattern of the radiation absorbing elements. The collimator center-to-center distance is approximately equal to twice the center-to-center distance of the groups of adjacent sensor elements. The radiation detector (3) further comprises a low-pass filter for receiving the combiner-signals and suppressing components of the combiner-signals with a frequency equal to or higher than a collimator frequency corresponding to the collimator center-to-center distance, thus providing a radiation detector which is easier to manufacture than the known radiation detector and which requires a relatively low degree of precision for the positioning of the radiation absorbing elements of the imaging radiation-collimating structure without introducing visible Moire effects in the image of an object to be imaged by the detector.

### FIELD OF THE INVENTION

The invention relates to a radiation detector comprising

a detector array having a periodical pattern of detector elements, each detector element comprising a sensor element for converting incident radiation into an electrical charge, and the sensor elements being spaced at a sensor center-to-center distance,

an imaging radiation-collimating structure disposed over the detector array and having a periodical pattern of radiation absorbing elements being spaced at a collimator center-to-center distance.

### BACKGROUND OF THE INVENTION

Such a radiation detector is known from the US patent application US2003/0076929. The known radiation detector comprises an array of detector elements and a stray radiation grid or a collimator of absorbent structure elements to reduce the amount of scattered radiation incident on the detector elements. The absorbent structure elements are fashioned such that their detector side center-to-center spacing in at least one direction, i.e. in the row direction or the column direction, is greater by a whole-numbered factor than the center-to-center spacing of the detector elements, thus avoiding disturbing Moiré effects in the image of an object to be imaged by the detector.

A disadvantage of the known radiation detector is that an adequately precise manufacturing and positioning of the absorbent structure elements of the imaging radiation-collimating structure with respect to the detector elements is required.

### SUMMARY OF THE INVENTION

It is an object of the invention to provide a radiation detector of the kind mentioned in the opening paragraph which is easier to manufacture than the known radiation detector and which requires a relatively low degree of precision for the positioning of the radiation absorbing elements of the imaging radiation-collimating structure without introducing visible Moiré effects in the image of an object to be imaged by the detector.

This object is achieved by a radiation detector according to the invention characterized in that

the radiation detector comprises a combiner for generating combiner-signals from the electrical charges of the sensor elements of groups of an even number of sensor elements adjacent in a direction of the periodicity of the pattern of the radiation absorbing elements,

the collimator center-to-center distance is approximately equal to twice the center-to-center distance of the groups of adjacent sensor elements, and

the radiation detector comprises a low-pass filter for receiving the combiner-signals and suppressing components of the combiner-signals with a frequency equal to or higher than a collimator frequency corresponding to the collimator center-to-center distance.

By generating combiner-signals from electrical charges of the sensor elements of groups of an even number of adjacent sensor elements, a functional Modulation Transfer Function (MTF) of the detector array is introduced. The combiner-signals have a zero modulation response of the functional MTF at a functional sample frequency of the detector array which corresponds to the center-to-center distance of adjacent groups of sensor elements. Related to the functional sample frequency is a functional Nyquist frequency. During the sampling process the modulation response of the combiner-signals is sampled for frequencies up to the functional Nyquist frequency. For frequencies higher than the functional Nyquist frequency, the modulation response of the combiner-signals is folded back with respect to the functional Nyquist frequency. For these frequencies the modulation reponse of the combiner-signals doesn't contain image information but just noise. Therefore, for frequencies higher than the functional Nyquist frequency, the modulation response of the combiner-signals is contributing in a negative sense to an image to be formed by the detector.

The imaging radiation-collimating structure is disposed over the detector such that the direction of the periodicity of the pattern of radiation absorbing elements corresponds to the direction wherein the sensor elements and the groups of sensor elements are adjacent. The modulation response of the combiner-signals equals the product of the functional MTF of the detector array and the frequency characteristics of the imaging radiation-collimating structure (wherein the latter is an intrinsic property of the imaging radiation-collimating structure). When the modulation response of the combiner-signals exceeds a certain threshold value, Moiré effects become visible in the image to be formed by the detector, thus considerably degrading the image quality of the image to be formed by the detector.

When the collimator center-to-center distance of the radiation absorbing elements of the imaging radiation-collimating structure is approximately equal to twice the center-to-center distance of the groups of adjacent sensor elements, the corresponding collimator frequency is approximately equal to the functional Nyquist frequency. The low-pass filter suppresses the first order harmonic component (ground modulation) of the modulation response of the combiner-signals at the collimator frequency. The second order harmonic component of the modulation response of the combiner-signals is located close to the functional sample frequency of the detector array and has a value close to zero, since the functional MTF of the detector array equals zero at the functional sample frequency. Because of this value close to zero, the second order harmonic component of the modulation response of the combiner signals doesn't exceed the aforementioned threshold value and doesn't introduce visible Moiré effects in the image to be formed by the detector. Notably, when in the direction of the periodicity of the pattern of the radiation absorbing elements the sensor elements are equally sized and equally spaced, a minimum value is obtained for the second order harmonic component of the modulation response of the combiner signals, which results in a maximal suppression of Moiré effects in the image to be formed by the detector.

The higher order harmonic components of the modulation response of the combiner-signals have inherently low values and especially the higher harmonics of the modulation response of the combiner-signals are suppressed by the functional MTF of the detector array.

In contrast to the known radiation detector there is no need for the radiation detector according to the invention to have an imaging radiation-collimating structure with a collimator center-to-center distance being exactly equal to a whole-numbered factor times the sensor center-to-center distance. For the radiation detector according to the invention it is sufficient to roughly match the collimator center-to-center distance of the imaging radiation-collimating structure to twice the center-to-center distance of the groups of adjacent sensor elements. This makes the radiation detector according to the invention easier to manufacture than the known radiation detector and requires a relatively low degree of precision for the positioning of the radiation absorbing elements of the imaging radiation-collimating structure with respect to the detector elements.

A further advantage of the radiation detector according to the invention is that such a radiation detector is very useful in the technological evolution towards radiation detectors with smaller detector elements, which allows images to be formed at a higher resolution so that more details of the object to be imaged are visible in the image formed by the radiation detector. The known manufacturing methods for imaging radiation-collimating structures require a precise positioning of the radiation absorbing elements with respect to the detector elements. However, when evolving towards smaller detector elements, precise positioning of the radiation absorbing elements with respect to the detector elements becomes more of a problem. Since the collimator center-to-center distance of a radiation detector according to the invention has to be approximately equal to twice the center-to-center distance of the groups of an even number of sensor elements adjacent in a direction of the periodicity of the pattern of the radiation absorbing elements, the radiation detector according to the invention allows shifting of the limiting resolution of the imaging radiation-collimating structure with a factor that equals twice the number of sensor elements for which the electrical charges are combined into groups.

An even further advantage of the radiation detector according to the invention is that, when evolving towards smaller detector elements and consequently towards smaller sensor center-to-center distances, it is not necessary to evolve towards imaging radiation-collimating structures to the same extent. As explained before, a functional MTF of the detector array is introduced by generating combiner-signals from electrical charges of the sensor elements of groups of an even number of adjacent sensor elements. With respect to the MTF of the radiation detector according to the invention, which is related to the sensor center-to-center distance, the functional MTF of the radiation detector according to the invention is shifted towards lower frequencies. To maximally suppress Moiré effects in the image to be formed by the detector, it is in general necessary to have a second order harmonic component of a modulation response signal (which equals the product of the MTF of the detector array multiplied by the frequency characteristics of the imaging radiation-collimating structure) which is located close to the sample frequency of the detector array and has a value close to zero. Especially for radiation detectors according to the invention with detector arrays having a linear fill factor smaller than 1, the radiation detector according to the invention is extremely advantageous, since in contrast to what one would expect the functional MTF of the radiation detector according to the invention shifts to lower frequencies, while the MTF of the known radiation detector having a linear fill factor smaller than 1, shifts to higher frequencies.

A particular embodiment of a radiation detector according to the invention is characterized in that the combiner comprises an adder and a readout, which readout reads out the electrical charges of the sensor elements thus generating sensor element signals, and which adder adds the sensor element signals of adjacent sensor elements thus generating the combiner-signal. In this embodiment first the electrical charges of the sensor elements are read out and subsequently the read out signals are added by the adder. The modulation response of the combiner-signals thus generated is less affected by the imaging radiation-collimating structure than the modulation response of signals originating directly from the individual sensor elements. This embodiment is preferred when the detector elements of the detector array comprise only one sensor element per detector element. When the detector elements of the detector array comprise only one sensor element, the electrical charges of a group of an even number of adjacent sensor elements that have to be combined by the combiner are coming from adjacent detector elements. In this case the electronics of the individual detector elements are part of the combiner. They serve as a plurality of readouts and they generate sensor element signals. A separate adder, which is also part of the combiner, adds the sensor element signals of an even number of adjacent sensor elements, thus generating a combiner-signal. This particular embodiment of the invention has the advantage that the technology involved is relatively simple.

Another particular embodiment of a radiation detector according to the invention is characterized in that the combiner comprises an adder and a readout, which adder adds the electrical charges of adjacent sensor elements to accumulated electrical charges, and which readout reads out the accumulated electrical charges thus generating the combiner-signal. In this embodiment first the electrical charges of the sensor elements are added by the adder to accumulated electrical charges and subsequently the accumulated electrical charges are read out by the readout. The modulation response of the combiner-signals thus generated is less affected by the imaging radiation-collimating structure than the modulation response of signals originating directly from the individual sensor elements. This embodiment is preferred when the detector elements of the detector array comprise more than one sensor element per detector element. When the detector elements of the detector array comprise more than one sensor element, the electrical charges of a group of an even number of adjacent sensor elements that have to be combined by the combiner are coming from adjacent detector elements or from just one detector element. An advantage of this particular embodiment of the invention is that due to the adding of the electrical charges of the sensor elements an accumulated electrical charge is achieved before the actual read out is performed by the readout, so that for a radiation detector according to the invention less combiner-signals have to be read out than for the known radiation detector for which the electrical charges of the individual sensor elements have to be read out separately.

From both particular embodiments as described before, it becomes clear that the combiner-signals can be formed (i) in a selectable mode of operation of the radiation detector and (ii) outside of the detector array which therefore doesn't need a specially adapted and complex circuit layout to read out the combiner-signals. An advantage of both particular embodiments is that when the radiation detector according to the invention has detector elements comprising a sensor element that covers the same area of the detector elements as the sensor elements of the detector elements of the known radiation detector, the radiation detector according to the invention shows a far better suppression of the Moiré effects due to the imaging radiation-collimating structure than the known radiation detector.

A further embodiment of a radiation detector according to the invention is characterized in that the adjacent sensor elements of an individual group of sensor elements are directly electrically connected. They can for example be directly electrically connected by metal lines, a-Si, ITO or ITO-like materials. These electrical connections form adders for individual groups of adjacent sensor elements and are part of the combiner. An advantage of this embodiment is that the modulation response of the generated combiner-signals is less affected by the imaging radiation-collimating structure than the modulation response of signals originating directly from the individual sensor elements, while the detector array doesn't need a specially adapted and complex circuit layout to read out the combiner-signals.

A preferred embodiment is a radiation detector according to the invention wherein the detector elements are sensitive to X-rays and wherein the imaging radiation-collimating structure is a stray radiation grid.

Another preferred embodiment is a radiation detector according to the invention, wherein the detector elements are sensitive to gamma radiation and wherein the imaging radiation-collimating structure is a collimator. In the field of nuclear medicine the source for gamma radiation is located in the inside of an organ of a patient to be examined. Unscattered gamma radiation emitted from an organ of the patient that strikes the detector array produces a time curve of the activity of the organ. This time curve allows conclusions of the function of the organ. Scattered gamma radiation that strikes the detector array considerably degrades the image quality of the image to be detected by the detector. Therefore it is essential to use a collimator to absorb as much as possible scattered gamma radiation. The collimator is disposed over the detector array and has a regular pattern of radiation absorbing elements which define the projection direction of the image to be detected. The collimator allows the unscattered gamma radiation to strike the detector array. Gamma radiation that is not incident on the detector array in this direction, particularly scattered gamma radiation, is absorbed or considerably attenuated by the radiation absorbing elements of the collimator.

### BRIEF DESCRIPTION OF THE DRAWINGS

These and other aspects of the invention will be elucidated with reference to the drawings wherein

FIG. 1 schematically shows a side view of a medical X-ray examination apparatus provided with a flat X-ray detector according to an exemplary embodiment of the present invention,

FIG. 2a shows a graphical representation of the modulation transfer function (MTF) of the detector array of a know flat X-ray detector having a linear fill factor equal to 1,

FIG. 2b shows a graphical representation of the modulation transfer function (MTF) of the detector array of a known flat X-ray detector having a linear fill factor smaller than 1,

FIG. 3a shows a graphical representation of two modulation transfer functions (MTF) in a numerical example of a known radiation detector comprising a detector array having a sensor center-to-center distance of 100 μm, wherein:
graph (a) corresponds to the MTF of a detector array having a linear fill factor equal to 1
graph (b) corresponds to the MTF of a detector array having a linear fill factor equal to 0.65

FIG. 3b shows a graphical representation of three modulation transfer functions (MTF) in a numerical example of a radiation detector according to the invention comprising a detector array having a sensor center-to-center distance of 50 μm, wherein:
graph (a) corresponds to the MTF of a detector array having a linear fill factor equal to 1
graph (b) corresponds to the MTF a detector array having a linear fill factor equal to 0.65
graph (c) corresponds to the functional MTF of a detector array when combiner-signals are generated from the electrical charges of the sensor elements of groups of two sensor elements adjacent in a direction of the periodicity of the radiation absorbing elements,

FIG. 4a shows a graphical representation of the visibility of Moiré effects in a numerical example of a known flat X-ray detector comprising a detector array having a sensor center-to-center distance of 100 μm

FIG. 4b shows a graphical representation of the visibility of Moiré effects in a numerical example of a flat X-ray detector according to the invention,

FIG. 5 shows a schematic overview of a part of the detector array of a radiation detector according to the invention with detector elements comprising two sensor elements,

FIG. 6 shows a schematic overview of a part of the detector array of a particular embodiment of a radiation detector according to the invention wherein first the electrical charges of the sensor elements are read out and subsequently the read out signals are added by the adder,

FIG. 7 shows a schematic overview of a part of the detector array of a particular embodiment of a radiation detector according to the invention wherein first the electrical charges of the sensor elements are added by the adder to accumulated electrical charges and subsequently the read out signals are added by the adder,

FIG. 8 shows a schematic overview of a part of the detector array of a particular embodiment of a radiation detector according to the invention wherein the adjacent sensor elements of an individual group of sensor elements are directly electrically connected by e.g. metal lines,

FIG. 9 shows a schematic overview of a detector array of a known radiation detector.

### DETAILED DESCRIPTION OF THE INVENTION

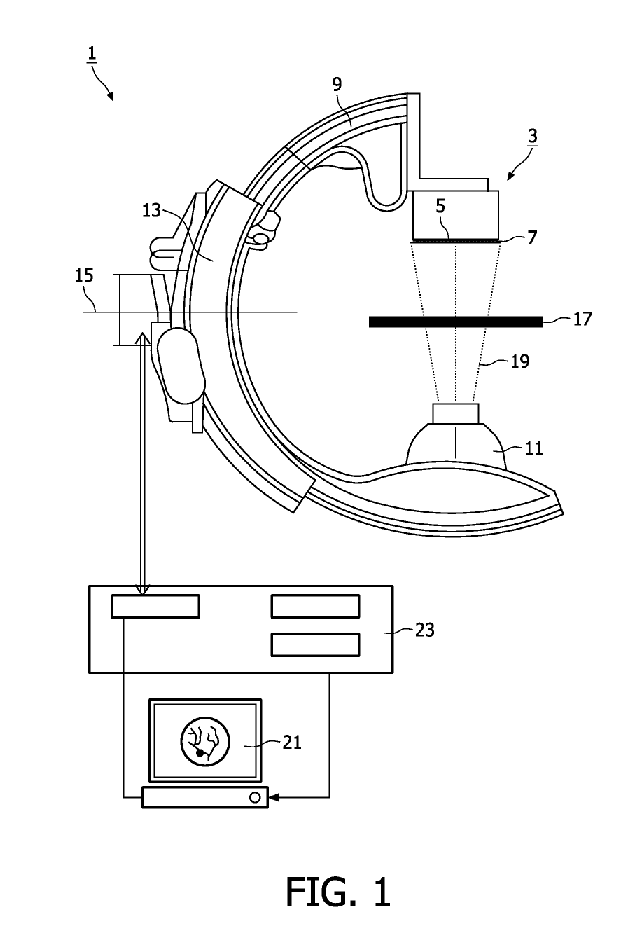

FIG. 1 schematically shows a side view of a medical X-ray examination apparatus 1 provided with a flat X-ray detector 3. The flat X-ray detector 3 is a radiation detector according to the invention and comprises a detector array 5 which is sensitive for X-rays, and a stray radiation grid 7. The X-ray examination apparatus 1 comprises a C-arm 9 from which an X-ray source 11 and the flat X-ray detector 3 are suspended. The C-arm 9 is movable through a sleeve 13 and rotatable around a horizontal axis 15. A patient table 17 is located between the X-ray source 11 and the flat X-ray detector 3. A patient to be examined (not shown) is to be positioned on the patient table 17.

To form an image of a part of the patient to be examined X-rays emanating from the X-ray source 11 propagate in straight lines 19 in the direction of the flat X-ray detector 3 thereby propagating through the patient. When propagating through the patient, a part of the X-rays is scattered, while another part of the X-rays is unscattered. When the unscattered X-rays strike the detector array 5 of the flat X-ray detector 3 they produce a spatially resolved attenuation value distribution of the part of the patient to be imaged. When the scattered X-rays strike the detector array 5 of the flat X-ray detector 3 they considerably degrade the image quality of the image detected by the detector. To improve the image quality of the image detected by the detector a stray radiation grid 7 is disposed over the detector array 5. This stray radiation grid 7 has a regular pattern of radiation absorbing elements, i.e. lead lamellae, which are focused in the direction of the X-ray source 11. At the side of the detector array 5 (i.e. at the side where the stray radiation grid 7 is disposed over the detector array 5) the radiation absorbing elements are spaced at a collimator center-to-center distance. Due to the stray radiation grid unscattered X-rays are allowed to strike the detector array 5 on a straight-line path 19. X-rays that are not incident on the detector array 5 in this direction, particularly scattered X-rays, are absorbed or considerably attenuated by the radiation absorbing elements of the stray radiation grid 7. Finally, to display the image of a part of the patient on a display 21, the image detected by the flat X-ray detector 3 is readout and converted into a visible image by means of electronics 23.

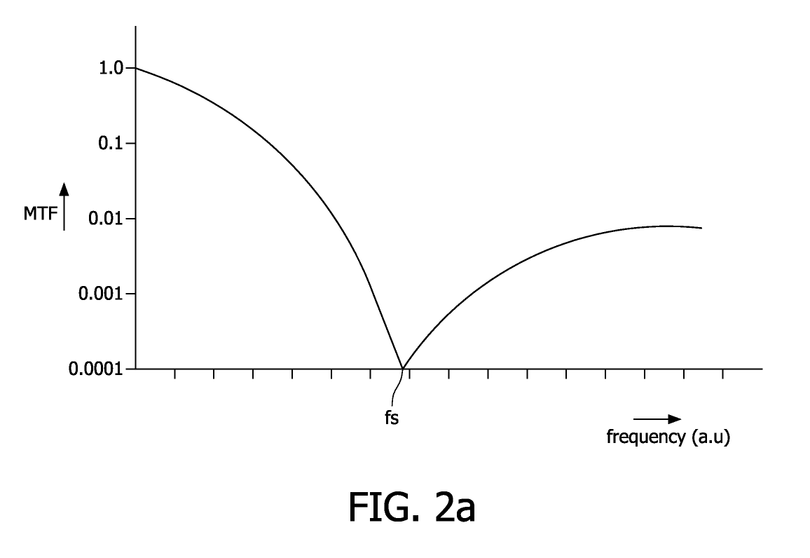

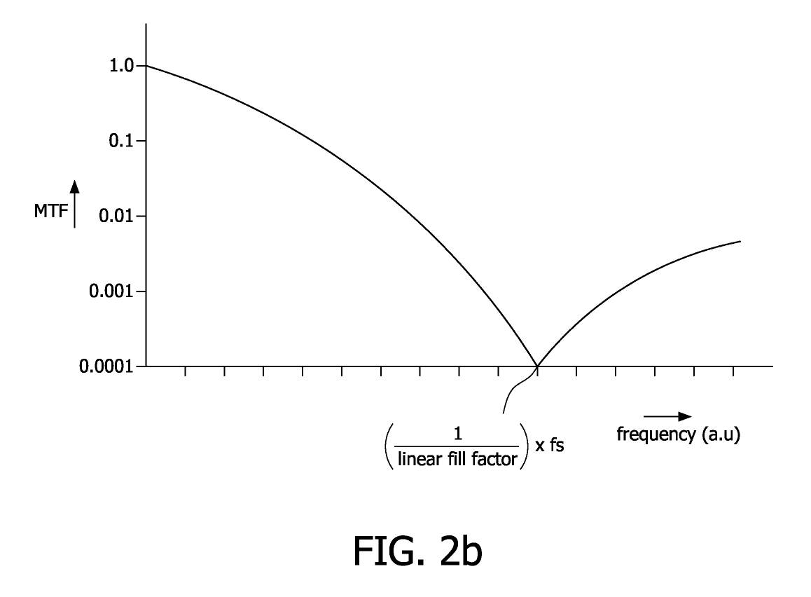

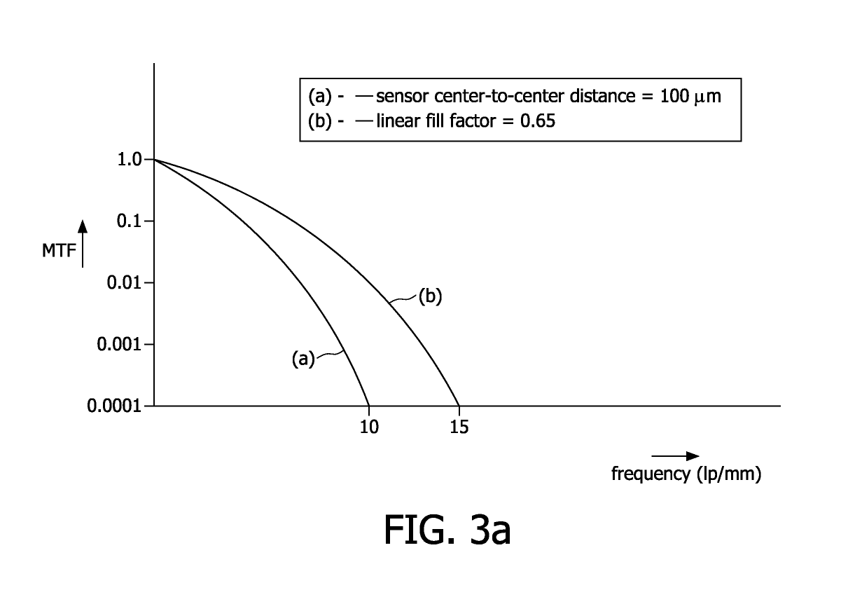

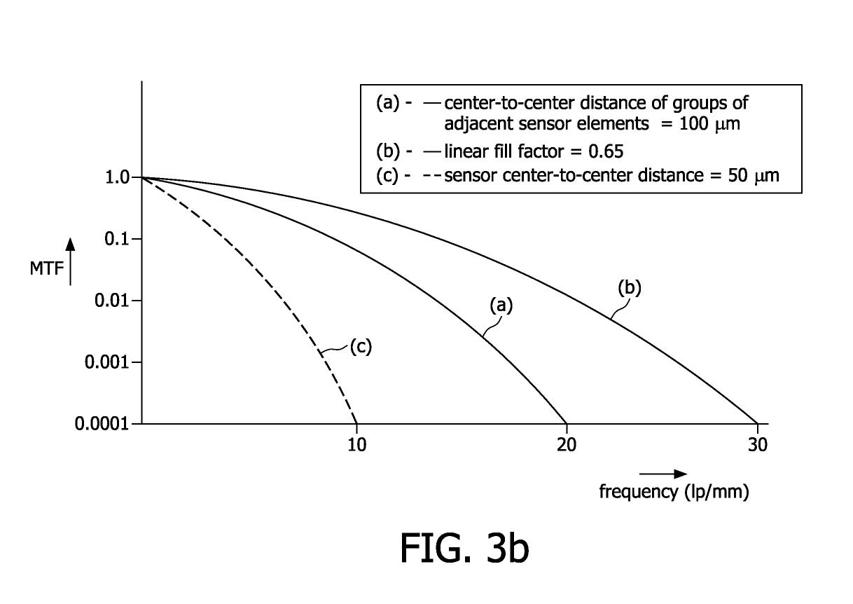

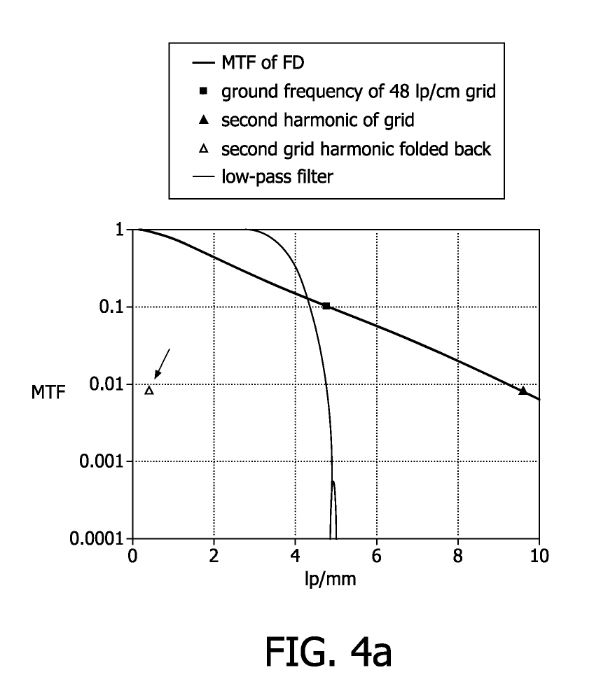

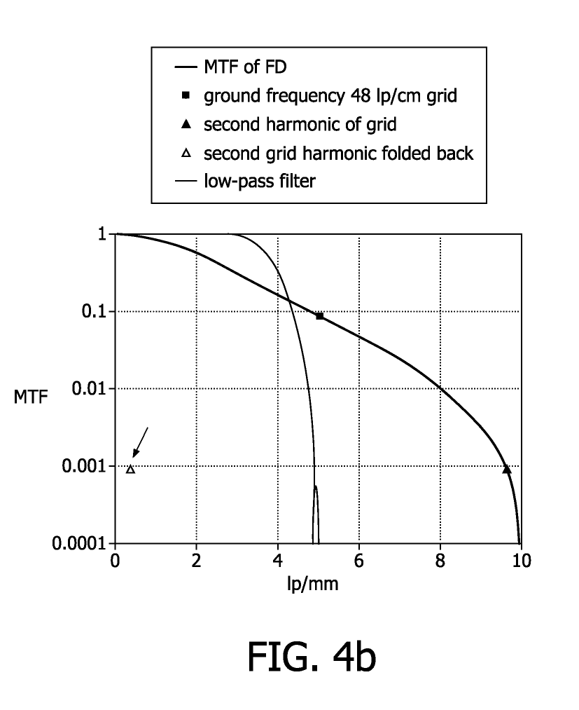

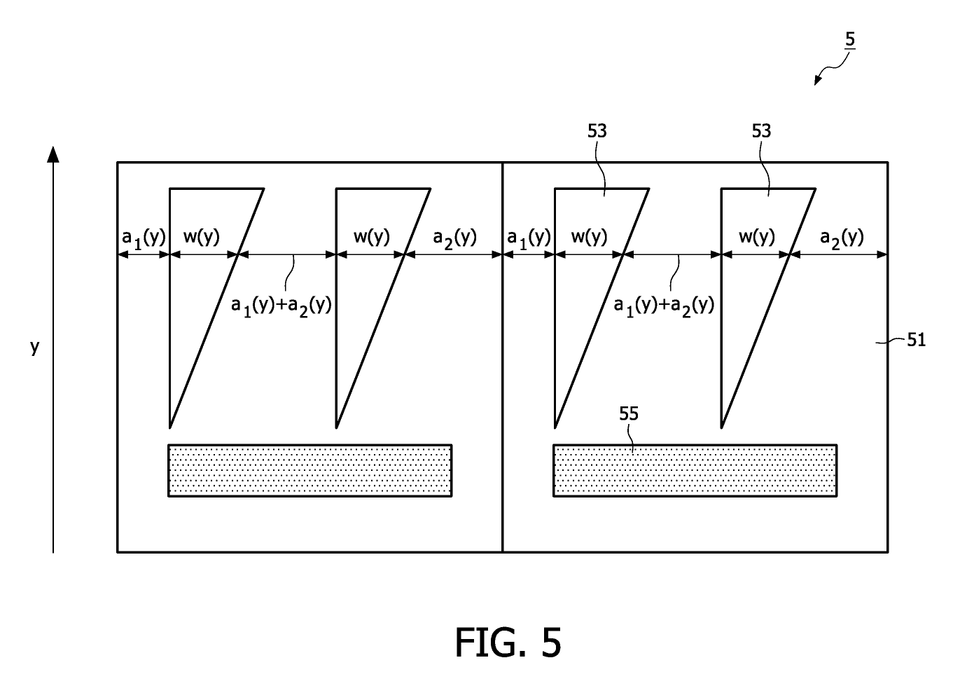

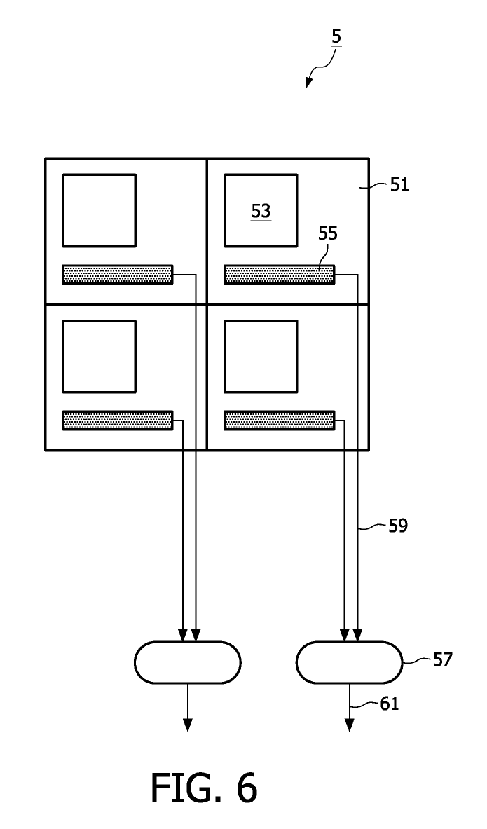

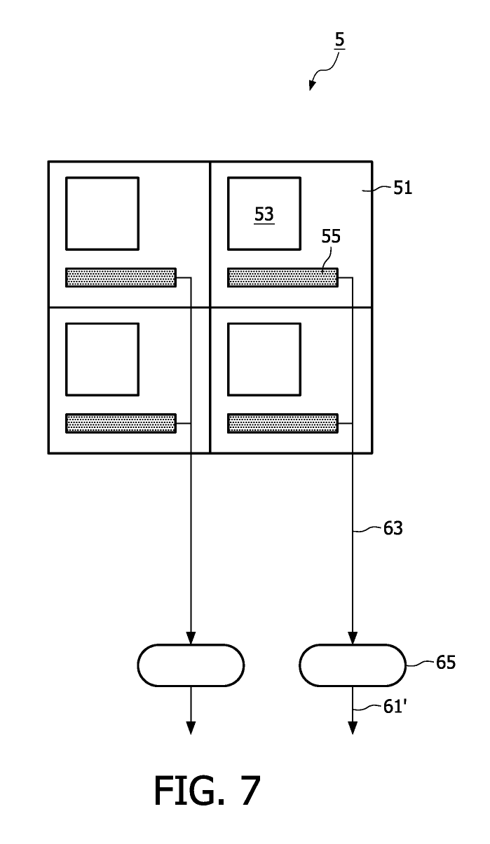

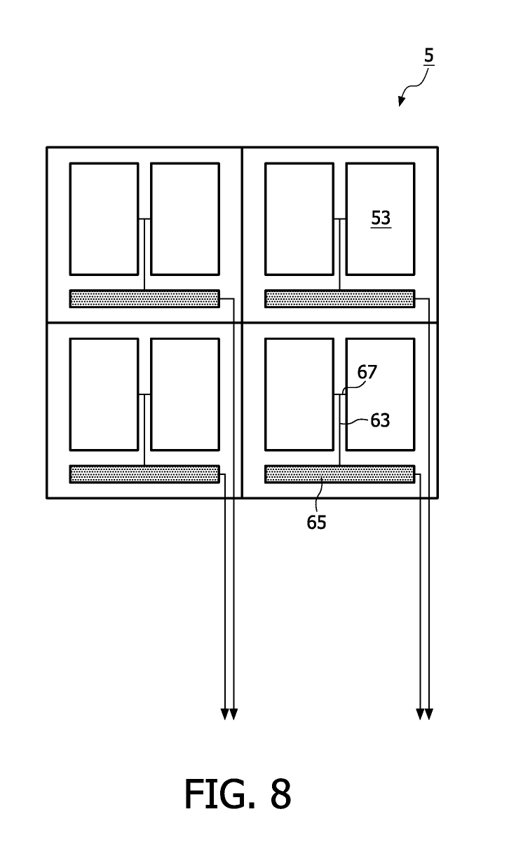

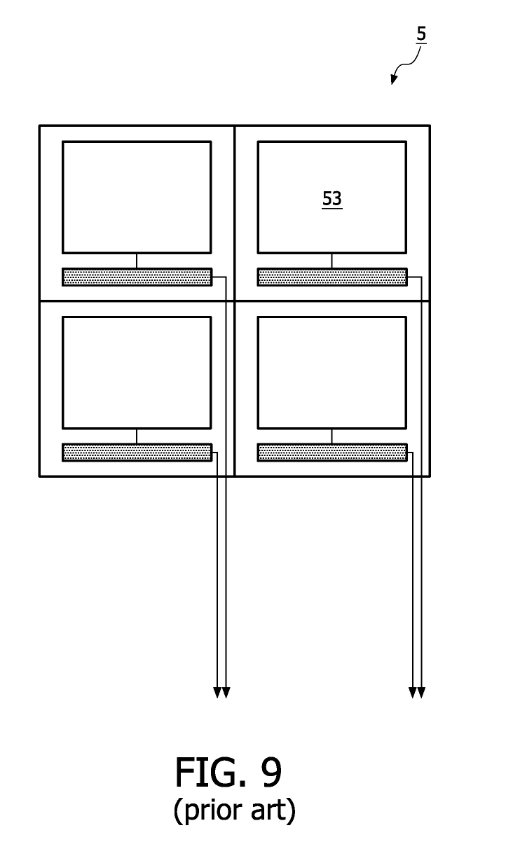

FIG. 2a shows a graphical representation of the modulation transfer function (MTF) of the detector array of a known flat X-ray detector having a linear fill factor equal to 1. Along the vertical axis the MTF is plotted on a logarithmic scale, while along the horizontal axis the frequency is plotted in arbitrary units. Provided that the linear fill factor in a direction of the periodicity of the detector array equals 1 (i.e. in a direction of the periodicity of the detector array the detector elements are completely covered by sensor elements), the MTF of the detector array equals a sine-function multiplied by the frequency characteristics of a conversion layer of the radiation detector. The MTF of the detector array has a first zero modulation response at the sample frequency fₛ, wherein the sample frequency fₛ equals 1/(sensor center-to-center distance of the detector array).

FIG. 2b shows a graphical representation of the MTF of the detector array of a known flat X-ray detector having a linear fill factor smaller than 1 (i.e. in a direction of the periodicity of the detector array the detector elements are only partially covered by sensor elements). Similar as in FIG. 2a, the MTF is plotted on a logarithmic scale along the vertical axis, while along the horizontal axis the frequency is plotted in arbitrary units. Provided that the linear fill factor in a direction of the periodicity of the detector array is less than 1, the MTF of the detector array equals a sine-function multiplied by the frequency characteristics of a conversion layer of the radiation detector. The MTF of the detector array has a first zero modulation response at a frequency equal to the sample frequency fₛ divided by the linear fill factor. As shown in FIGS. 2a and 2b, the first zero modulation response of the MTF of the detector array of a flat X-ray detector shifts to higher frequencies when the linear fill factor decreases.

FIG. 3a shows a graphical representation of two modulation transfer functions for different values of the linear fill factor in a numerical example of a known radiation detector comprising a detector array having a sensor center-to center distance of 100 μm. Along the vertical axis the modulation transfer functions are plotted on a logarithmic scale, while along the horizontal axis the frequency is plotted in numbers of line pairs per millimeter (lp/mm). The sample frequency fₛ of a detector array having a sensor center-to center distance of 100 μm is equal to 10 lp/mm. Graph (a) corresponds to the MTF of a detector array having a linear fill factor equal to 1. For graph (a) the MTF is a sine-function multiplied by the frequency characteristics of a conversion layer of the radiation detector. For graph (a) the MTF of the detector array has a first zero modulation response at the sample frequency fₛ′2 10 lp/mm. Graph (b) corresponds to the MTF of a detector array having a linear fill factor equal to 0.65. For graph (b) the MTF is a sine-function multiplied by the frequency characteristics of a conversion layer of the radiation detector. For graph (b) the MTF of the detector array has a first zero modulation response at the sample frequency fₛ multiplied by 1/(0.65)=15 lp/mm. Similar as in FIGS. 2a and 2b the first zero modulation response of the MTF of the detector array shifts to higher frequencies when the linear fill factor decreases.

FIG. 3b shows a graphical representation of three modulation transfer functions in a numerical example of a radiation detector according to the invention comprising a detector array having a sensor center-to center distance of 50 μm. Similar as in FIG. 3a, the modulation transfer functions are plotted on a logarithmic scale along the vertical axis, while along the horizontal axis the frequency is plotted in numbers of line pairs per millimeter (lp/mm). The sample frequency fₛ of a detector array having a sensor center-to center distance of 50 μm is equal to 20 lp/mm. Graph (a) corresponds to the MTF of a detector array having a linear fill factor equal to 1. For graph (a) the MTF is a sine-function multiplied by the frequency characteristics of a conversion layer of the radiation detector. For graph (a) the MTF of the detector array has a first zero modulation response at the sample frequency fₛ=20 lp/mm. Graph (b) corresponds to the MTF of a detector array having a linear fill factor equal to 0.65. For graph (b) the MTF is a sine-function multiplied by the frequency characteristics of a conversion layer of the radiation detector. For graph (b) the MTF of the detector array has a first zero modulation response at the sample frequency fₛ multiplied by 1/(0.65)=30 lp/mm. Graph (c), which is indicated by a dotted line, corresponds to the functional MTF of the detector array when combiner-signals are generated from the electrical charges of the sensor elements of groups of two sensor elements adjacent in a direction of the periodicity of the radiation absorbing elements. The functional MTF has a first zero response at the functional sample frequency fₛ′ of the detector array, which corresponds to the center-to-center distance of adjacent groups of two sensor elements. The functional sample frequency fₛ′ is independent of the linear fill factor of the detector array. This means that the functional sample frequency fₛ′ is equal to 10 lp/mm. As follows directly from FIGS. 3a and 3b, graph (c) of FIG. 3b is equal to graph (a) of FIG. 3a. This means that, completely indepent from the fill factor of the detector array of a radiation detector according to the invention, for a radiation detector according to the invention with a 50 μm sensor center-to-center distance, whereby the combiner-signals are generated from the electrical charges of the sensor elements of groups of two sensor elements adjacent in a direction of the periodicity of the pattern of the radiation absorbing elements, the same (functional) MTF is achieved as for a known radiation detector comprising a detector array with a sensor center-to-center distance of 100 μm and a linear fill factor equal to 1. Similar to this numerical example, for a radiation detector according to the invention having a specific sensor center-to-center distance, a linear fill factor smaller than 1, and comprising a combiner for generating combiner-signals from the electrical charges of the sensor elements of groups of an even number of sensor elements adjacent in a direction of the periodicity of the pattern of the radiation absorbing elements, a functional MTF can be achieved which is equal to the MTF of a known radiation detector having a linear fill factor equal to 1 and a sensor center-to-center distance which is equal to the center-to-center distance of the groups of an even number of sensor elements of the radiation detector according to the invention.

FIG. 4a shows a graphical representation of the visibility of Moiré effects in a numerical example of a known flat X-ray detector having a sensor center-to-center distance of 100 μm. The known flat X-ray detector comprises a stray radiation grid having a collimator frequency which is approximately equal to the Nyquist frequency of the detector array, i.e. the Nyquist frequency of the detector array is 5 lp/mm, while the collimator frequency (i.e. the ground frequency of the stray radiation grid) is 4.8 lp/mm. Along the vertical axis the MTF is plotted on a logarithmic scale, while along the horizontal axis the frequency is plotted in numbers of line pairs per millimeter (lp/mm). The second harmonic of the stray radiation grid is located at 9.6 lp/mm. The modulation response of the known flat X-ray detector equals the product of the MTF of the detector array and the frequency characteristics of the stray radiation grid. During the sampling process the modulation response is sampled for frequencies up to the Nyquist frequency of the detector array. For frequencies higher than the Nyquist frequency, the modulation response is folded back with respect to the Nyquist frequency, thus contributing in a negative sense to an image to be formed by the detector. The dotted line in FIG. 4a indicates the frequency characteristics of the low pass filter. The low pass filter suppresses components of the modulation response with a frequency equal to or higher than the collimator frequency (4.8 lp/mm). Thus, the ground frequency of the stray radiation grid is suppressed by the low pass filter. However, as indicated with an arrow in FIG. 4a the folded back second harmonic of the stray radiation grid at 0.4 lp/mm is not suppressed by the low pass filter. This component of the modulation response has a value of just below 0.01 (i.e. 1%). In this specific numerical example Moiré effects become visible in the image to be formed by the detector if the modulation response exceeds a threshold value of 0.0015 (i.e. 0.15%). From FIG. 4a it is clear that for the known flat X-ray detector Moiré effects are visible in the image to be formed by the detector.

FIG. 4b shows a graphical representation of the visibility of Moiré effects in a numerical example of a flat X-ray detector according to the invention, having a sensor center-to-center distance of 50 μm. Along the vertical axis the MTF is plotted on a logarithmic scale, while along the horizontal axis the frequency is plotted in numbers of line pairs per millimeter (lp/mm). Combiner-signals are generated from the electrical charges of the sensor elements of groups of two sensor elements adjacent in a direction of the periodicity of the stray radiation grid. By doing so the functional MTF of the detector array is introduced. The combiner-signals have a zero modulation response of the functional MTF at a functional sample frequency of 10 lp/mm. Related to the functional sample frequency is a functional Nyquist frequency. The flat X-ray detector according to the invention comprises a stray radiation grid having a collimator frequency which is approximately equal to the functional Nyquist frequency of the detector array, i.e. the Nyquist frequency of the detector array is 5 lp/mm, while the collimator frequency (i.e. the ground frequency of the stray radiation grid) is 4.8 lp/mm. The second harmonic of the stray radiation grid is located at 9.6 lp/mm. The modulation response of the combiner-signals equals the product of the functional MTF of the detector array and the MTF of the stray radiation grid. During the sampling process the modulation response of the combiner-signals is sampled for frequencies up to the functional Nyquist frequency of the detector array. For frequencies higher than the functional Nyquist frequency, the modulation response of the combiner-signals is folded back with respect to the functional Nyquist frequency, thus contributing in a negative sense to an image to be formed by the detector. Similar to FIG. 4a the dotted line in FIG. 4b indicates the frequency characteristics of the low pass filter. The low pass filter suppresses components of the modulation response of the combiner-signals with a frequency equal to or higher than the collimator frequency (4.8 lp/mm). Thus, the ground frequency of the stray radiation grid is suppressed by the low pass filter. As indicated with an arrow in FIG. 4b the folded back second harmonic of the stray radiation grid at 0.4 lp/mm is not suppressed by the low pass filter. This component of the modulation response of the combiner-signals has a value of just below 0.001 (i.e. 0.1%), which is well below the threshold value of 0.0015 (i.e. 0.15%) of the specific numerical example of FIGS. 4a and 4b. Therefore, for a radiation detector according to the invention no visible Moiré effects are introduced in the image of an object to be imaged by the detector.

The threshold value of 0.0015, which indicates whether or not Moiré effects will be visible in the image to be formed by the detector, also indicates the extent to which the collimator center-to-center distance may deviate from twice the center-to-center distance of the groups of adjacent sensor elements. It is however to be noted that the threshold value of 0.0015 in the example of FIGS. 4a and 4b depends on the exact circumstances during the imaging process.

FIG. 5 shows a schematic overview of a part of the detector array 5 of a radiation detector according to the invention with detector elements 51 comprising two sensor elements 53 and electronics 55, like source followers, switches, gain capacitors, etc. Next to the part of the detector array 5 an arrow indicates the y-direction which is the direction wherein the radiation absorbing elements of the stray radiation grid mainly extend. Perpendicular to the y-direction and in the plane of FIG. 5 is the direction of the periodicity of the pattern of the radiation absorbing elements. In the images to be formed by the detector, the Moiré effects are best suppressed when the requirement is fulfilled that in the direction of the periodicity of the pattern of the radiation absorption elements for each value of y the sensor elements 53 are equally sized and equally spaced, i.e. for a specific value of y all sensor elements 53 have a width w(y), while the distance between two sensor elements 53 is a₁(y)+a₂(y), wherein a₁(y) is the distance between one side of the detector element 51 and the sensor element 53, and a₂(y) is the distance between the sensor element 53 and the other side of the detector element 51. Consequently the sensor elements within a detector element can be arbitrary shaped as long as the aforementioned requirement is fulfilled.

FIG. 6 shows a schematic overview of a part of the detector array 5 of a particular embodiment of a radiation detector according to the invention wherein first the electrical charges of the sensor elements 53 of groups of an even number of sensor elements are read out and sensor element signals 59 are generated. Subsequently the sensor element signals 59 of separate groups of an even number of sensor elements 53 are added by separate adders 57, thus resulting in combiner-signals 61. Like the separate adders 57, the electronics 55 of the individual detector elements 51 are part of the combiner. The electronics 55 serve as a plurality of readouts. Equivalently, in stead of adding the sensor element signals 59, the electrical voltages of separate groups of an even number of sensor elements 53 can be averaged by separate adders 57.

FIG. 7 shows a schematic overview of a part of the detector array 5 of a particular embodiment of a radiation detector according to the invention wherein first the electrical charges of the sensor elements 53 of groups of an even number of sensor elements are added by adders (not explicitly shown) to accumulated electrical charges 63. Subsequently the accumulated electrical charges 63 of separate groups of an even number of sensor elements 53 are read out by separate readouts 65, thus resulting in combiner-signals 61′. Like the separate readouts 65, the electronics 55 of the individual detector elements 51 are part of the combiner. They serve as a plurality of adders and they accumulate electrical charges 63. Equivalently, in stead of adding the electrical charges of the sensor elements to accumulated electrical charges 63, the electrical voltages can be averaged by the adder of separate groups of an even number of sensor elements so that subsequently the averaged electrical voltages can be read out by the readout.

FIG. 8 shows a schematic overview of a part of the detector array 5 of a particular embodiment of a radiation detector according to the invention as shown in FIG. 7. The adjacent sensor elements 53 of an individual group of sensor elements are directly electrically connected by metal lines 67 thus accumulating the electrical charges of the separate sensor elements 53 of the groups of an even number of sensor elements. Subsequently the accumulated electrical charges 63 of separate groups of an even number of sensor elements 53 are read out by separate readouts (not shown) thus resulting in combiner-signals.

FIG. 9 shows a schematic overview of a detector array 5 of a known radiation detector. From the comparison of FIG. 8 to FIG. 9, it is clear that when the total area of the sensor elements 53 in a group of an even number of sensor elements in a radiation detector according to the invention is equal to the area of a separate sensor element of the known radiation detector, the resolution of both radiation detectors is equivalent. However, when evolving towards smaller detector elements, it is not necessary for the radiation detector according to the invention to evolve towards smaller imaging radiation collimating structures to the same extent, which makes it possible to evolve towards smaller detector elements without being hampered by state of the art manufacturing process of the imaging radiation collimating structures.

1. A radiation detector (3) comprising
a detector array (5) having a periodical pattern of detector elements (51), each detector element comprising a sensor element (53) for converting incident radiation into an electrical charge, and the sensor elements being spaced at a sensor center-to-center distance,
an imaging radiation-collimating structure (7) disposed over the detector array (5) and having a periodical pattern of radiation absorbing elements being spaced at a collimator center-to-center distance,
characterized in that
the radiation detector (3) comprises a combiner for generating combiner-signals from the electrical charges of the sensor elements (53) of groups of an even number of sensor elements adjacent in a direction of the periodicity of the pattern of the radiation absorbing elements,
the collimator center-to-center distance is approximately equal to twice the center-to-center distance of the groups of adjacent sensor elements, and
the radiation detector (3) comprises a low-pass filter for receiving the combiner-signals and suppressing components of the combiner-signals with a frequency equal to or higher than a collimator frequency corresponding to the collimator center-to-center distance.

2. A radiation detector (3) as claimed in claim 1, characterized in that the combiner comprises an adder (57) and a readout, which readout reads out the electrical charges of the sensor elements (53) thus generating sensor element signals, and which adder adds the sensor element signals (59) of adjacent sensor elements thus generating the combiner-signal (61).

3. A radiation detector (3) as claimed in claim 1, characterized in that the combiner comprises an adder and a readout (65), which adder adds the electrical charges of adjacent sensor elements to accumulated electrical charges (63), and which readout reads out the accumulated electrical charges thus generating the combiner-signal (61′).

4. A radiation detector (3) according to claim 3, characterized in that the adjacent sensor elements (53) of an individual group of sensor elements are directly electrically connected.

5. A radiation detector (3) according to claim 1,
wherein
the detector elements (51) are sensitive to X-rays and wherein the imaging radiation-collimating structure (7) is a stray radiation grid.

6. A radiation detector (3) according to claim 1,
wherein the detector elements (51) are sensitive to gamma radiation and wherein the imaging radiation-collimating structure (7) is a collimator.
